(19) United States
(12) Patent Application Publication
(10) Pub. No.: US 2001/0032071 A1
(43) Pub. Date: Oct. 18, 2001

(54) Portable data recording and/or data playback device

(76) Inventors: Bernd Burchard, Ottoorunn (DE); Stefan Vogel, Bamberg (DE)

Correspondence Address: Peter F. Corless, EDWARDS & ANGELL, LLP, Diki, Bronstein, Roberts & Cushman, IP Group, P.O. Box 9169, Boston, MA, 02209, US

(21) Appl. No.: 09/775,307

(22) Filed: Feb. 1, 2001

(30) Foreign Application Priority Data
Feb. 1, 2000 (DE) DE 100 04 284.8

(51) Int. Cl. G10L 19/00

(52) U.S. Cl. 704/200.1

(57) ABSTRACT

A portable data recording and/or data playback device, according to the first design example, includes a headband (1) which contains all functional parts such as a speaker (2), microphone (6), power supply (4), recording/playback unit (3, 5) and operating elements (8). The portable data recording and/or data playback device may be equipped with a speech recognition function (5, 6, 14) so that the cumbersome manual operation of the device is eliminated. The overall operational comfort for the user will thus be significantly improved.

### FIELD OF THE INVENTION

This invention pertains to a portable device for the recording and playback of data, such as audio or video data, according to the main concept of claim 1 or 10.

Portable devices for playing audio data, such as portable cassette, CD or MP3 players, usually include a case for the device, which contains the corresponding player and power supply, as well as a cord-connected headband or headphone which contains speakers for the playback of audio data. The device case is also equipped with various operating elements, such as controls, switches or buttons which enable a user to control the operation of the respective device manually. If the user, however, carries the device in his jacket pocket or the like, he has to take out the device to operate it and to access the operating elements. Certain operating steps even require the user to able to see the desired operating element to guarantee the safe operation and setting of the device. Moreover, the user must at least have one hand free for the operation of the device.

The above description makes it clear that the operating comfort for these known portable devices is limited. The same is also true for other portable devices for the recording and/or playback of audio, video or other kinds of data.

It is, therefore, the task of this invention to suggest a portable data recording and/or data playback device which offers the user improved operating comfort.

### SUMMARY OF THE INVENTION

This task is being solved by the invention through a portable data recording and/or data playback device.

More particularly, in a first aspect, a portable data recording and/or data playback device with data capture and/or output devices for the capture and/or output of data is provided, where the device comprises data memory and/or data readout devices for storing captured data in a data memory unit and/or for reading out data for output from the data memory unit, and with operating controls for controlling the operation of the portable data recording and/or data playback device, wherein the data capture and/or data output devices, the data memory and/or reading devices as well as the operating controls are contained in one unit in the form of a headband.

In a further aspect, the invention provides a portable data recording and/or data playback device, that comprising data capture and/or data output devices for the capture and output of data, with data memory and/or data readout devices for storing captured data in a data memory unit and/or for reading out data for output from the data memory unit, and with operating controls for controlling the operation of the portable data recording and/or data playback device, wherein the operating controls include sound capture devices for the capture of a sound signal, and speech recognition devices for the detection of a user voice command contained in the sound signal, and for the conversion of voice commands to a corresponding control command for the portable data recording and/or data playback device.

Thus, the invention provides combining all functional elements of the device in one part which takes on the form of a headband or headphone. This way, the headphone and case are no longer separate items. The headphone in particular also has the necessary operating controls for a user-specific operation of the device. The user, therefore, no longer has to take the device itself out of his jacket pocket or the like, in order to use it. Altogether, this design example offers an extremely compact portable device which is easy to operate for the recording and/or playback of data.

According to a second design example of this invention, the device has a speech recognition feature so that the device can be operated by voice commands. Voice control enables a more comfortable operation of the device. Since no sensitive operating elements, such as switches, controls or buttons are necessary, the device can be built more ruggedly and manufacturing costs can be reduced.

The portable device according to the second design example above can be constructed like the previously described traditional portable device in which the headphone or headband is separate from the device case itself. In that case, it is recommended that the microphone, which is needed to for speech recognition, will be combined with the headphone in form of a headset. In addition, it is also possible to combine the second and first design examples in such a way that a compact device will be created, which is controlled by speech and in which all functional elements are contained in one element in form of a headband or headphone; and that for the speech recognition at least a microphone has to be connected to the headband and a corresponding speech recognition software is implemented in the device. This combination has special advantages since on the one hand you can create an extremely compact device and on the other you do not need any visual contact when operating the device.

The portable data recording and/or data playback device can be designed for the recording and/or playback of audio, video or other data. The design of the device in form of MP3 player has the special advantage that the data medium which is being used in this case is very small and uses very little energy, and that no moving mechanical parts are needed for the playback of MP3 data. The invention, of course, can also be applied to portable devices that record or play back the desired data through mechanical recording and playback devices, such as cassette, CD or DVD players.

Other aspects of the invention are disclosed infra.

### BRIEF DESCRIPTION OF THE DRAWINGS

FIG. 1 shows a device in form of a portable MP3 player according to a first design example of this invention,

FIG. 2 shows a device in form of a portable MP3 player according to a second design example of this invention, and

FIG. 3 shows the potential construction of the separate device unit of the device shown in FIG. 2 in form of a block diagram.

### DETAILED DESCRIPTION OF THE INVENTION

In the following, this invention will be explained in more detail with the help of preferred design examples and with reference to the drawing.

The invention will be explained in the following with the aid of a MP3 player for the playback of audio data. The invention can, however, in the same way be applied to playback or recording devices for other media, such as CDs, cassettes, multimedia cards, minidisks, etc., and other kinds of data.

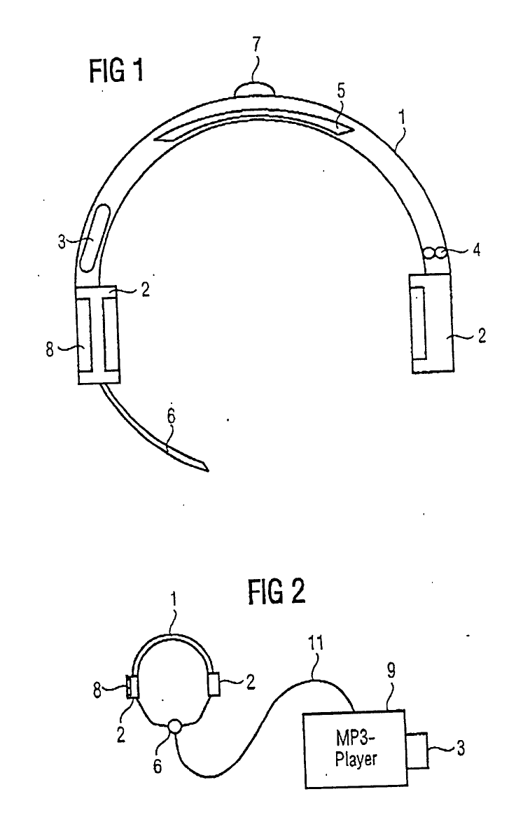

The MP3 player shown in FIG. 1 includes a headband or headphone 1 which contains all functional elements necessary for the operation of the MP3 player.

Headband 1 thus includes an interface 3 for the connection of an appropriate data medium which stores the audio data for playback in MP3 format. In addition, headband 1 contains the electronics for the device which read the audio data from the data medium, decompress and convert them to corresponding electrical analog audio signals, amplify and send them to electro-acoustic transducers or speakers 2, which turn the audio signals into the corresponding sound signals. On one side of the headband 1, a keyboard 8 is attached for the operation of the device, so that the user by pressing the respective key can for instance manually turn the device on and off, control the volume and tone, or chose single titles from the ones stored on the data medium. The headband 1 also contains the electrical supply unit 4 of the device. In this instance a battery case which can hold one or more batteries 4.

The design example shown in FIG. 1 also has provisions for attaching a microphone 6 to the headband 1 so that the user will be able to give voice commands which will control the operation of the MP3 player. The sound signals which are being captured through the microphone 6 will be evaluated by the electrical unit 5 with the aid of a speech recognition algorithm so that the voice commands spoken by the user will be recognized and converted into the corresponding control signals for the MP3 player.

In addition, the headband 1 also includes a data interface 7 which makes an external data exchange possible. The data interface 7 can be designed as wired or, preferably, wireless. In the second case, the interface can be designed as an infrared or radio interface. Through this data interface 7, audio data can be loaded directly from an external device or server to the MP3 player. In addition, audio data can also be transmitted to an external receiver through data interface 7.

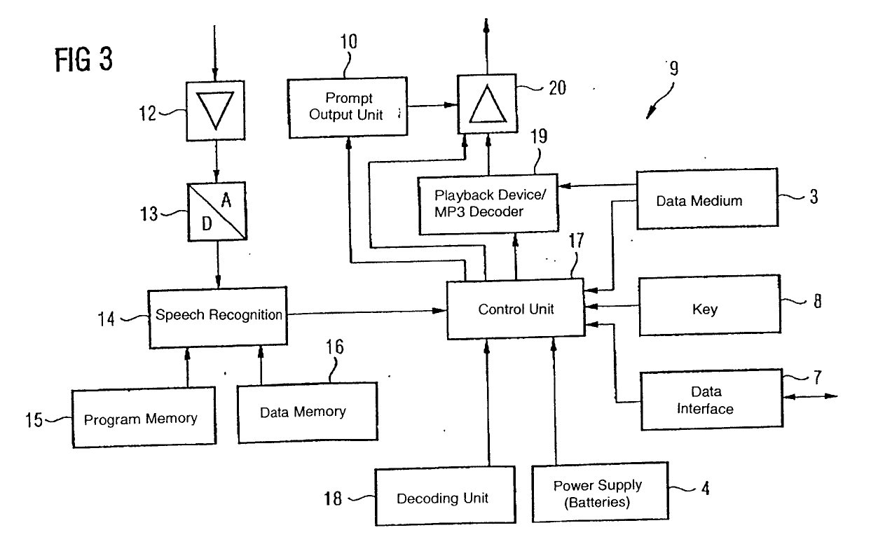

The device shown in FIG. 2 is also a MP3 player; in this case, the functional parts needed for the playback of the MP3 data are contained in a case 9 which is connected to a so-called headset by a cord 11. The headset includes a headphone or headband 1 with speakers 2 and a microphone 6. Optionally, a key 8 for certain operations is attached to the side of the headset. As shown in FIG. 2, a data medium with stored MP3 data can be introduced to the case 9 via an appropriate interface.

The MP3 player shown in FIG. 2 is essentially operated by voice control. For this purpose, the sound signals which are being received through the microphone 6 will be evaluated with the aid of an appropriate speech recognition unit so that the voice commands spoken by the respective user will be recognized and converted into the corresponding control signals for the MP3 player. The provision for voice control eliminates the need for manual controls.

As shown in FIG. 3, the case 9 of the MP3 player contains a power supply 4, for instance a battery.

A microphone amplifier 12 amplifies the sound signals, which have been captured by the microphone 6, and sends them to an analog/digital transducer 13 for conversion to corresponding digital data. A speech recognition unit 14, which accesses a program memory 15, which contains the control program for the operation of the speech recognition unit, and a data memory 16 for the temporary storage of data, recognizes the respective user's voice commands contained in the sound signals. A control unit 17 then controls the device according to these voice commands as well as according to optional control data which are read directly from data medium 3. This way, the user is able to set by voice control for instance the playback volume, tone, or music titles to be played, etc.

The data medium 3 for an MP3 player preferably is a flash memory card. The data, which have been stored on the data medium 3, are being decoded or decompressed by a playback unit and converted to a corresponding audio signal, which is sent through a speaker amplifier 20 to the speakers 2 of the headphone 1, and are converted by these to the corresponding sound signals. The tasks of the speech recognition unit 14, the control unit 17 and the playback unit 19 can be handled by a single processor.

The control unit 17 also evaluates the operation of the already mentioned, optional key 8 on headphone 1. With this key 8, the user can for instance switch the device on and off or activate the functions of the speech recognition unit 14. It may e.g. be necessary to press the key 8 shortly to switch the device on, while pressing the key 8 longer will switch the device off. When no data are played back anymore, the device will automatically turn itself off after a certain amount of time to conserve energy.

In addition, the design example in FIG. 3 has provisions for a decoding unit 18 which makes coded data accessible to the user. The decoding unit 18 is preferably exchangeable like the data medium 3. In addition, as already explained for FIG. 1, there are provisions for a data interface 7 through which data can be loaded directly from a server to the device.

To facilitate the operation, there are provisions for a prompt output unit 10. The prompt output can be implemented as a visual display, for instance a LED or LCD display, or an acoustic output in form of a voice prompt function for which the use of a text-to-speech algorithm is useful.

Speech recognition can be realized in different ways. The user can for instance activate the speech recognition with a specific word (keyword spotting principle). With this kind of speech recognition, no further operational control is required for the device. The device is completely controlled by voice. However, it is also possible that the already mentioned key 8 at the headphone needs to be pressed before the input of voice commands (touch-to-talk principle), in which case the entire operation of the device is controlled by this one key 8 and voice.

Trough prompt output 10, the device, after being switched on, can for instance output the name of the data medium 3 and the number of titles stored on this medium. The user can then through a corresponding voice command enter the title he wants to have played back, and set the volume or switch to another title, etc. For comfortable operation, the speech recognition feature of the MP3 player should for instance understand the following words or corresponding functional equivalents in the language of the respective country: “Menu” to call up the content of the data medium, “Title 1” to select title number 1; “Playback”, “Record”, “Louder”, “Quiet”, “Next title”, “Last title”, “Back”/“Forward” to rewind/forward, “Fast back”/“Fast forward” to rewind/forward quickly, “Pause”, “Stop”, “To beginning”, “To end”, “Repeat”, “Repeat all titles”, “Playtime” to find out the length of the playtime, “Title length” to find out the playback time for a title, “Fast run”, etc.

What is claimed is:

1. A portable data recording and/or data playback device, comprising data capture and/or output devices for the capture and/or output of data, with data memory and/or data readout devices for storing captured data in a data memory unit and/or for reading out data for output from the data memory unit, and with operating controls for controlling the operation of the portable data recording and/or data playback device,
wherein the data capture and/or data output devices, the data memory and/or reading devices as well as the operating controls are contained in one unit in the form of a headband.

2. A portable data recording and/or data playback device according to claim 1, wherein the data output devices include at least one electro-acoustic transducer for the output of audio data.

3. A portable data recording and/or data playback device according to claim 1, wherein the data capture devices include at least one microphone for the capture of audio data.

4. A portable data recording and/or data playback device according to claim 1, wherein the data reading devices and data output devices are designed for reading out and playing back MP3 data.

5. A portable data recording and/or data playback device according to claim 1, wherein there is a provision for energy supply devices for the delivery of electrical energy, whereby the energy supply devices are also contained in the headband.

6. A portable data recording and/or data playback device according to claim 1, wherein the operating controls include a keyboard, which is attached to the headband, for the manual operation of the device by a user.

7. A portable data recording and/or data playback device according to claim 1, wherein the operating controls include a microphone, which is attached to the headband, for the capture of a sound signal, and a speech recognition device, which is contained in the headband, for the recognition of a user voice command within the sound signal and for the conversion of the voice command to a corresponding control command for the portable data recording and/or data playback device.

8. A portable data recording and/or data playback device according to claim 1, wherein there are provisions for data interface devices to receive external data and/or send data to an external receiver and that the devices are contained in the headband.

9. A portable data recording and/or data playback device according to claim 8, wherein the data interface devices are designed for wireless data transmission.

10. A portable data recording and/or data playback device, comprising data capture and/or data output devices for the capture and output of data, with data memory and/or data readout devices for storing captured data in a data memory unit and/or for reading out data for output from the data memory unit, and with operating controls for controlling the operation of the portable data recording and/or data playback device,
wherein the operating controls include sound capture devices for the capture of a sound signal, and speech recognition devices for the detection of a user voice command contained in the sound signal, and for the conversion of voice commands to a corresponding control command for the portable data recording and/or data playback device.

11. A portable data recording and/or data playback device according to claim 10, wherein the data capture and/or data output devices are contained in a headband.

12. A portable data recording and/or data playback device according to claim 11, wherein the sound capture devices include at least one microphone which is integrated with the headband.

13. A portable data recording and/or data playback device according to 10, wherein the data output devices include at least one electro-acoustic transducer for the playback of audio data.

14. A portable data recording and/or data playback device according to claim 10, wherein the data capture device includes at least one microphone for recording audio data.

15. A portable data recording and/or data playback device according to claim 10, wherein the data readout devices and the data output devices are designed for the readout and output of MP3 data.

16. A portable data recording and/or data playback device according to claim 10, wherein the operating controls include at least one key for the manual operation of the portable data recording and/or data playback device.

17. A portable data recording and/or data playback device according to claim 11 or 16, wherein at least one key is attached to the headband.

18. A portable data recording and/or data playback device according to claim 16, wherein there are provisions for at least one key to switch the portable data recording and/or data playback device on or off and to activate the speech recognition device.

19. A portable data recording and/or data playback device according to claim 10, wherein there are provisions for decoding devices for the decoding of coded output data.

20. A portable data recording and/or data playback device according to claim 10, wherein there are provisions for operating information output devices which output operating information to the user during the operation of the portable data recording and/or data playback device and help the user with the operation of the device.

21. A portable data recording and/or data playback device according to claim 20, wherein the operating information output devices are designed for acoustic and/or visual output of the operating information.

22. A portable data recording or playback device, comprising
a data capture device or data output device; and
a data memory device or data readout device,
wherein i) data capture device or data capture device, and ii) the data memory device or the data readout device, are contained in a headband.

23. The device of claim 22 further comprising operating controls for the data memory device or the data readout device, and the operating controls contained in the headband.

24. The device of claim 22 further comprising operating controls that comprise sound capture apparatus for capture of a sound signal.

25. The device of claim 24 further comprising operating controls that comprise a speech recognition apparatus for the detection of a user voice command contained in a sound signal and for the conversion of voice commands to a corresponding control command.

26. A portable data recording or playback device, comprising
a data capture device or data output device;
a data memory device or data readout device; and
operating controls.

27. The device of claim 26 wherein the operating controls comprise sound capture apparatus for capture of a sound signal.

28. The device of claim 26 further comprising operating controls that comprise a speech recognition apparatus for the detection of a user voice command contained in a sound signal and for the conversion of voice commands to a corresponding control command.
